(19) United States
(12) Patent Application Publication
(10) Pub. No.: US 2022/0223026 A1
(43) Pub. Date: Jul. 14, 2022

(54) ITEM SEPARATION ALERTING SYSTEMS AND METHODS

(71) Applicant: Thomas H. Hillery, Henderson, NV (US)

(72) Inventor: Thomas H. Hillery, Henderson, NV (US)

(21) Appl. No.: 17/144,169

(22) Filed: Jan. 8, 2021

(51) Int. Cl. G08B 21/24; H04W 4/80; G08B 5/22; G08B 3/10

(52) U.S. Cl. CPC G08B 21/24; G08B 3/10; G08B 5/22; H04W 4/80

(57) ABSTRACT

A system for alerting of an item being potentially lost, comprising a transmitter device configured to be attached to a physical item, wherein the transmitter device emits one or more detectable short range signals, and a receiver device configured to detect one or more short range signals emitted from the first data communication device, and actuate an alert condition responsive to the failure to detect the one or more short range signals emitted from the first data communication device, wherein the alert condition actuates one of a visible or auditory alert through one or both of the audio device and the multimedia device.

### BACKGROUND OF THE INVENTION

The invention relates generally to systems, methods and devices for providing automated notifications, and more particularly, to a system, method and device for automatically alerting of the conditions that may lead to an item becoming lost, before the item actually becomes lost. Invariably, people lose, misplace or have their keys stolen for automobiles, homes, boats, motorcycles, businesses, elevator fobs, safety deposit boxes, post office boxes, etc., (collectively referred to as “lost keys”). The loss may occur anywhere, for example in the home, airports, hotels, or even in a different state or country. However, depending on the type of keys, duplicating keys can be quite difficult and costly. For example, certain “advanced” keys for automotive, motorcycle, boat or house keys contain electronically stored data which cost anywhere from $200 to as much as $1,500 to replace. These “advanced” keys are generally programmable, comprising of non-metal keys with multi-dimensional surfaces and may further comprise of compressible buttons. They are quite popular with car manufacturers and owners as they provide for automatic electronic access, e.g. to car doors, locking and unlocking a car's steering or ignition, and starting the ignition. Depending on where the keys are lost, there might be an issue of compromised security. For example, if key loss occurs outside the comfort of one's home, then the challenge becomes finding the keys before a break-in and/or theft occurs or additional costs are incurred for a locksmith. Generally, a key owner will conduct a comprehensive search for the lost keys hoping to retrace their steps.

Many times keys are lost because they fall or are dropped, or are put down someplace and left behind. Thus, this separation between owner and item can be easily resolved if the owner of the item was made aware of that they are leaving the item behind.

Accordingly, it would be desirable and there is a need for a device which resolves the aforementioned issues, among others, by alerting an owner of an item, such as keys, at the time the owner leaves the keys behind.

### SUMMARY OF THE INVENTION

The invention is generally directed to systems and devices which resolve the issues cited above, among others.

Some embodiments of the invention are directed to a system for alerting of a potential loss of a physical item by mounting a transmitter on the physical item, wherein the transmitter includes a data storage device, a motion sensor and processor and is in communication with a receiver, the receiver including a data storage device and a processor and being configured for generating an alert responsive to determining that a preset threshold condition is satisfied, wherein the preset threshold condition may relate to a detection of movement changes of the physical item via the transmitter mounted thereon and/or the physical item being positioned in a location outside of a preset range of the receiver.

In some embodiments, the transmitter and receiver are in communication through wireless technology, short range or Bluetooth technology.

In some embodiments, the transmitter and/or receiver include a global positioning system (GPS) unit.

In some embodiments, the receiver is a smartphone.

In some embodiments, the receiver includes an audio device and the alert comprise an audio alert.

In some embodiments, the receiver includes an illumination device or a display device and the alert comprises illumination of the illumination device or a viewable display on the display device.

In some embodiments, the threshold condition relates to the detection of movement changes over time, such that a detected increase in the rate of movement or acceleration of movement satisfies the threshold condition.

In some embodiments, the threshold condition relates to the detection of movement changes in direction, such that a detected directional change of movement satisfies the threshold condition.

In some embodiments, the threshold condition relates to the detection of movement changes comprises detecting vibration of the physical item.

In some embodiments, the preset range of the receiver is five feet.

In some embodiments, the trackable device further comprises an audio device, wherein the audio device on the trackable device is configured to emit an audible alarm responsive to the satisfaction of the threshold condition.

Some embodiments of the invention are directed to a system for alerting of an item being potentially lost, comprising: a transmitter device configured to be attached to a physical item, wherein the transmitter device includes a processor, first data communication device and an audio device, wherein the first data communication device emits one or more detectable short range signals; and a receiver device having a second data communication device, memory, a software application residing in memory, a second processor and a multimedia device, wherein, responsive to execution of the software application by the second processor, the receiver device actuating the second data communication device to detect one or more short range signals emitted from the first data communication device, actuating an alert condition responsive to the failure to detect the one or more short range signals emitted from the first data communication device, wherein the alert condition actuates one of a visible or auditory alert through one or both of the audio device and the multimedia device.

In some embodiments of the system, the receiver device is a smartphone.

In some embodiments of the system, the alert condition triggers a display of a map on the multimedia device, the map including the location at which the alert condition was actuated.

In some embodiments of the system, the second processor actuates a notification responsive to detecting the one or more short range signals emitted from the first data communication device subsequent to actuating an alert condition.

Some embodiments of the invention are directed to a system for immediately alerting of an item being potentially lost, a transmitter device configured to be attached to the item, wherein the transmitter device includes a processor, first data communication device and an audio device, wherein the first data communication device emits one or more detectable signals; and a downloadable software application residing in memory on a smartphone, the smartphone having a second data communication device and a multimedia device, wherein, responsive to execution of the downloadable software application, actuating the second data communication device to detect one or more signals emitted from the first data communication device, actuating an alert condition responsive to the failure to detect the one or more signals emitted from the first data communication device, wherein the alert condition actuates one of a visible or auditory alert through one or both of the audio device and the multimedia device.

Other embodiments, features and advantages of the invention will be readily appreciated and apparent from the following detailed description when considered in connection with the accompanying drawings.

### BRIEF DESCRIPTION OF THE DRAWINGS

Other advantages of the invention will be readily appreciated as the same becomes better understood by reference to the following detailed description when considered in connection with the accompanying drawings. The components in the figures are not necessarily to scale, emphasis instead being placed upon illustrating the principles of the invention.

FIG. 1 is a representation of an exemplary embodiment of the invention;

FIG. 2 is a schematic diagram illustrating some of the components of an exemplary system constructed in accordance with the invention; and

FIG. 3 is a process flow chart of an exemplary process of the invention.

### DETAILED DESCRIPTION OF THE INVENTION

Details, features, and advantages of the apparatuses, systems and methods of the invention will become further apparent in the following detailed description of embodiments thereof. Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well.

The functionality and principles of the embodiments disclosed herein may be implemented by or with software programs, executable instructions and applications, operating in connection with computer hardware, such as data input/output or communication devices, data processing devices, display devices and data storage devices, which may be within the same housing or independent and connected remotely. It is expected that one of ordinary skill, notwithstanding the many design choices motivated by, for example, available time, current technology, and economic considerations, when guided by the concepts and principles disclosed herein will be readily capable of generating such software and executable instructions, including instructions regarding the establishment of a connection between a receiver and transmitter, and the criteria for providing an alert through one or both of the receiver and transmitter. Therefore, in the interest of brevity and minimization of any risk of obscuring the principles and concepts according to this embodiment of the invention, further discussion of such software and hardware, if any, will be limited to the essentials with respect to the principles and concepts used by the preferred or exemplary embodiments.

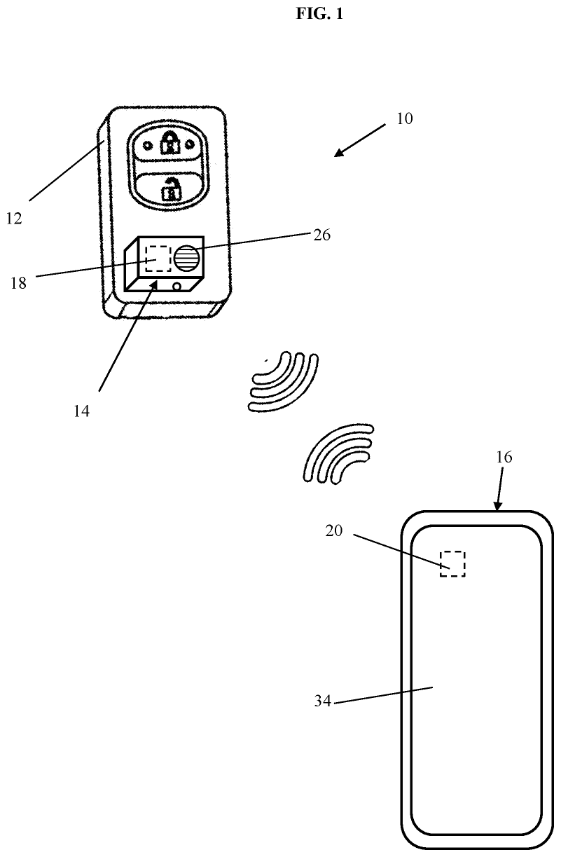

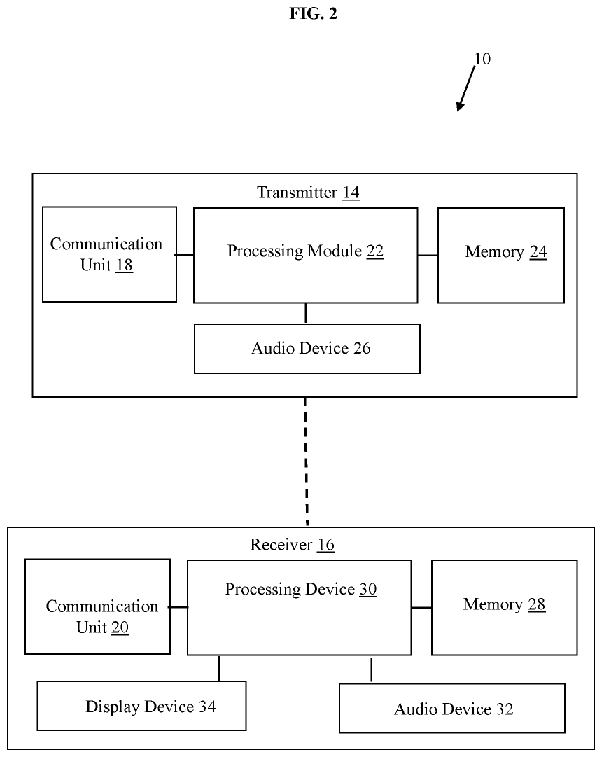

With reference to FIGS. 1-2, a system 10 of the invention includes a physical item 12 upon which a transmitter 14 of the invention is disposed and a receiver 16. Physical item 12 is depicted as a key fob for an automobile, but may be any item. Typically item 12 is something that is carried by the user, such as for example a wallet, purse, key, briefcase or backpack. Transmitter 14 may be embedded or incorporated with the item or added thereto after purchase, such as through adhesive or other conventional means of forming a secure engagement. Receiver 16 may be an independent device or a user's smartphone as depicted herein that is adapted to provide the features disclosed herein, such as through an added software application making use of existing hardware components of the smartphone.

Transmitter 14 includes a signal communication unit 18 and receiver 16 includes a signal communication unit 20 which are enabled for signal communication with one another. In this embodiment, signal communication units 18 and 20 utilize generally short range, low power, technology. Some illustrative, but non-limiting, examples of this technology are low frequency (125 kHz) antennas, radio frequency (>300 MHz) antennas, microwave frequency antennas, electric field antennas, blue tooth technology, etc.

In some embodiments, communication units 18 and 20 may pair with one another. Signal communication unit 18 may include unique identification information for transmitter 14 such that unit 20 is able to distinguish transmitter 14 by the signal from unit 18.

Transmitter 14 of this embodiment includes a processing module 22, a memory 24 with executable programming therein for enabling processing module 22 to provide the features described herein and an audio device 26. Responsive to processing module 22 determining that a threshold condition stored in memory 24 is satisfied or not satisfied, depending on the particular configuration, processing module 22 may actuate audio device 26 to emit an audible sound, such as spoken words or an alarm.

It should be understood that the threshold condition may be any condition indicative of a separation between transmitter 14 and receiver 16 suggesting that a user may have unintentionally left transmitter 14 behind, and thus, item 12 as well. For example, the condition may be based on the cessation of a signal from transmitter 14 being received by unit 20 or units 18 and 20 no longer being paired.

In some embodiments, processing module 22 of transmitter 14 further includes a motion sensor or GPS unit, or is otherwise configured to detect movement. Receiver 16 may further include GPS or motion detection, such as through existing technology in the case of receiver 16 being a smartphone or as provided via a software application of the invention which may be downloaded onto receiver 16, stored in memory 28 and operated by processing device 30 of receiver 16. In such embodiments a threshold condition may be satisfied based on the determination that transmitter 14 and receiver 16 have moved a preset distance from one another. Upon the threshold condition for an alert being satisfied, receiver 16 may display a map of the approximate location where the threshold condition was satisfied.

In some embodiments, the motion sensing feature of processing module 22 can detect the movement of transmitter 14 at a velocity or rate of acceleration that differs from receiver 16. Any of these movement changes or differences may be used as one or more of the threshold conditions for response. The response may include an audible sound on one or both of transmitter 14 via audio device 26 and receiver 16 via audio device 32. The satisfaction of the threshold condition may therefore be recognized by one or both of processing module 22 of transmitter 14 and processing device 30 of receiver 16, which may be via execution of the software application of the invention residing in memory 28. For example, a threshold condition may be satisfied responsive to the detection that transmitter 14 is no longer moving at the same or a similar rate of speed or in the same or a similar direction relative to receiver 16, or vice versa.

A software application of the invention residing in memory 28 of receiver 16 can be configured to provide an alert via a display device 34 on receiver 16. The alert may also include a query for the user to dismiss the alert via contact with display device 34. The software application may use GPS or other methods to provide an indication of the location of transmitter 14 at the time or point at which the threshold condition was satisfied. For example, receiver 16 may be used to inform a user of the last known location of transmitter 14 prior to, as discussed above, the physical separation, unpairing or failure to receive signals from, by or between, transmitter 14 and receiver 16.

In some embodiments, subsequent to a threshold condition being satisfied, such as the receiver 16 and transmitter 14 being separated or being moved in alternative directions, a notification or second alert may be provided by one or both of receiver 16 and transmitter 14 upon the threshold condition being unsatisfied. For example, after transmitter 14 and receiver 16 detect a lack of communication or unpairing, a notification may be provided on receiver 16 responsive to transmitter 14 and receiver 16 pairing again indicating that the transmitter 14 and receiver 16 are in sufficient range of one another. The notification on receiver 16 of the condition that caused an alert being reconciled can be used to assist a user in finding transmitter 14 (and therefore item 12) after being lost, such as for example, by communicating that receiver 16 is in proximity to transmitter 14. In some embodiments, upon reestablishing connection, receiver 16 may automatically or otherwise be used to trigger the playing of an audible sound through audio device 26 of transmitter 14 to further assist in locating transmitter 14 along with item 12.

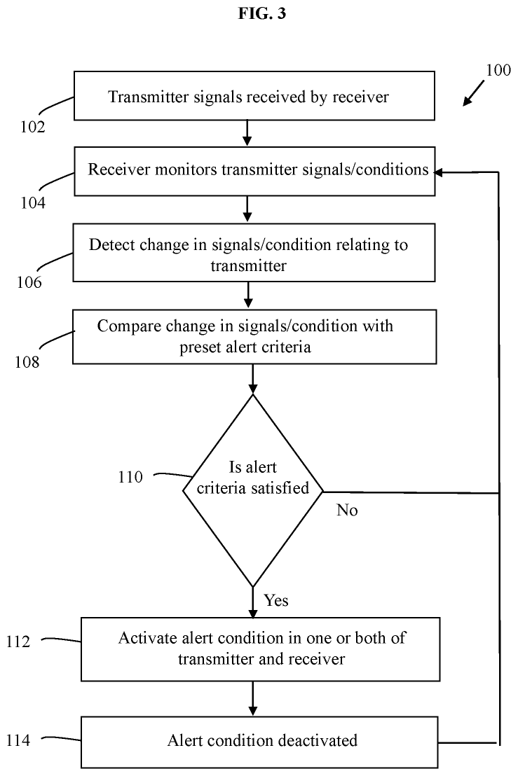

An exemplary process of operation of the invention is generally referred to in FIG. 3 by the reference numeral 100. Process 100 is initiated at 102 to determine or establish a starting condition of a transmitter and receiver of the invention, which may include data communication being received by the receiver indicating the transmitter is within range, or pairing by or between the transmitter and receiver. As shown by step 104, conditions are monitored in that data communication between or from transmitter to receiver is detected. As shown in steps 106 and 108, responsive to a change in the condition being detected, the new condition is compared with a preset threshold value or alert criteria for determining the existence of an alert condition. For example, the unpairing, failure to receive data signals for a preset period of time, separation in distance from one another, detection of acceleration or velocity changes (such as if the transmitter were to remain in the same position while the receiver remains in possession during travel, that is, if the item with the transmitter is left behind while a user with a smartphone as the receiver moves away) may be new conditions detected and compared with the preset alert criteria in steps 106 and 108.

As shown by step 110, if the preset criteria is not satisfied then conditions continue to be monitored in step 104. If the preset criteria is satisfied (such as by the unpairing of the receiver and transmitter, or the failure of the receiver to receive a signal from the transmitter), then as shown by step 112 an alert condition is activated. The alert condition may result in the playing of an audible alarm, flashing display and/or vibration of the receiver and/or transmitter. The alert condition may be deactivated either by a manual deactivation of the alert condition or the changing of the conditions that triggered the alert condition such that the preset criteria for the alert is no longer satisfied, such as for example, the receiving of a signal from the transmitter by the receiver or pairing of the receiver and transmitter.

In some embodiments, process 100 is embodied by a downloadable mobile application for use on a smartphone and is automatically enabled upon being paired with or receiving signals from a transmitter of the invention. In other embodiments, a Bluetooth setting must be enabled or the application must first be enabled.

It should be recognized that any or all of the components shown in a receiver or a transmitter, or both, may be implemented in a single or multiple devices, and any or all of the steps of process 100 may be conducted in one or both of the receiver and transmitter, such that satisfaction of the alert criteria may result in both receiver and transmitter actuating an alert condition.

Furthermore, the order of execution or performance of the operations in the embodiments of the invention illustrated and described herein is not essential, unless otherwise specified. Thus, the operations described herein may be performed in any order, unless otherwise specified, and embodiments of the invention may include additional or fewer operations than those disclosed herein. For example, it is contemplated that executing or performing a particular operation before, contemporaneously with, or after another operation, is within the scope of aspects of the invention.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” or the like, refer to the action and processes of a computer system, or similar electronic computing device (such as a specific computing machine), that manipulates and transforms data represented as physical (electronic) quantities within the computer system memories or registers or other such information storage, transmission or display devices.

It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein, such as a jackpot controller, mobile device, surveillance camera system and central server, among other things. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While the present invention has been disclosed with reference to certain embodiments, numerous modifications, alterations, and changes to the described embodiments are possible, as exemplified by embodiments that may incorporate a computer program, mobile and web application, software module and/or database as discussed below.

### Computer Program

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, Node, React, Redux or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, Google Play Store, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the methods, systems, and media disclosed herein include one or more databases, or use of the same. In view of the disclosure provided herein, those of skill in the art will recognize that many databases are suitable for storage and retrieval of alert conditions and information relating to a downloadable mobile application. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based.

In still further embodiments, a database is cloud computing-based. In other embodiments, a database is based on one or more local computer storage devices.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

What is claimed is:

1. A system for alerting of an item being potentially lost, comprising:
a transmitter device configured to be attached to a physical item, wherein the transmitter device includes a processor, first data communication device and an audio device, wherein the first data communication device emits one or more detectable short range signals; and
a receiver device having a second data communication device, memory, a software application residing in memory, a second processor and a multimedia device, wherein, responsive to execution of the software application by the second processor, the receiver device actuating the second data communication device to detect the one or more short range signals emitted from the first data communication device, actuating an alert condition responsive to detecting a threshold amount of difference between rates of movement over time for the transmitter device and the receiver device without a failure to detect the one or more short range signals emitted from the first data communication device, wherein the alert condition actuates one of a visible or auditory alert through one or both of the audio device and the multimedia device.

2. The system of claim 1, wherein the receiver device is a smartphone.

3. The system of claim 1, wherein the alert condition triggers a display of a map on the multimedia device, the map including the location at which the alert condition was actuated.

4. The system of claim 1, wherein the alert condition is actuated responsive to the failure to detect the one or more short range signals emitted from the first data communication device, and the second processor actuates a notification responsive to detecting the one or more short range signals emitted from the first data communication device subsequent to actuating the alert condition.
